(19) United States
(12) Patent Application Publication
(10) Pub. No.: US 2026/0349463 A1
(43) Pub. Date: Nov. 5, 2026

(54) OPERATING STRUCTURE

(71) Applicant: ABILITY ENTERPRISE CO., LTD., New Taipei City (TW)

(72) Inventors: Cheng-Kuang TSENG, New Taipei City (TW); Yung-Tseng YEN, New Taipei City (TW); Po-Ju LEE, New Taipei City (TW); Yu-Li TSAI, New Taipei City (TW); Chi-Jung YEH, New Taipei City (TW); Chin-Kang LEE, New Taipei City (TW); Pao-Tsang LEE, New Taipei City (TW)

(21) Appl. No.: 19/661,746

(22) Filed: Apr. 29, 2026

(30) Foreign Application Priority Data
Apr. 30, 2025 (TW) 114204357

(51) Int. Cl. G05G 5/03; G05G 1/01; G05G 1/10; G05G 5/05; G05G 11/00

(52) U.S. Cl. CPC G05G 5/03; G05G 1/01; G05G 1/10; G05G 5/05; G05G 11/00; G05G 2505/00; G05G 2700/32

(57) ABSTRACT

An operating structure includes a first operating member, a first elastic member, a locking member, a second elastic member, a second operating member, a translation member and a third elastic member. The first operating member is movable between a first position and a second position by the first elastic member. The first operating member is separated from the locking member at an engaging position, and abuts against the locking member at a disengaging position. The second elastic member applies a force to the locking member toward the engaging position. The second operating member is rotatable toward a retraction direction and/or an extension direction, or is positioned at a retracted position by the locking member. The translation member abuts against the second operating member located at the retracted position, and applies a force to the second operating member toward the extension direction by the third elastic member.

### CROSS-REFERENCE TO RELATED APPLICATIONS

This application claims the benefit of Taiwan application Serial No. 114204357, filed Apr. 30, 2025, the invention of which are incorporated by reference herein in its entirety.

### TECHNICAL FIELD

The present invention relates to an operating structure, and more particularly to a rotatable operating structure.

### BACKGROUND

Executing functional switching by tapping a touch screen has become a mainstream method for controlling electronic devices on the market due to the convenient and intuitive operation. However, such an operation lacks tactile feedback. When tapping the touch screen, a user must continuously monitor the screen to roughly estimate the tapping effect. Furthermore, since the user's fingers only move and slide on the smooth screen, there are often situations of over-operation or under-operation due to a lack of a toggling sensation. Consequently, the operation cannot be completed quickly and accurately, thereby failing to provide a favorable operating experience for the user.

### SUMMARY

The present invention relates to an operating structure capable of providing different operating modes within a limited space, wherein each of the operating modes is further provided with a force feedback sensation.

The present invention provides an operating structure including a housing, a first operating member, a first elastic member, a locking member, a second elastic member, a second operating member, a translation member and a third elastic member. The first operating member is rotatably disposed on the housing and is movable between a first position and a second position. The first elastic member connects to the housing and the first operating member, and the first operating member is at the first position or the second position by the first elastic member. The locking member is movable between an engaging position and a disengaging position. In the engaging position, the first operating member is separated from the locking member; in the disengaging position, the first operating member abuts against the locking member. The second elastic member connects to the housing and the locking member, and the second elastic member applies a force to the locking member toward the engaging position. The second operating member is rotatable toward a retraction direction and an extension direction about a first rotation axis. In a retracted state, the locking member is at the engaging position and stops the second operating member; in an extended state, the locking member is at the engaging position or the disengaging position, and the second operating member departs from a retracted position and is rotatable toward the retraction direction and the extension direction. The translation member abuts against the second operating member being in the retracted position, and the translation member applies a force to the second operating member toward the extension direction by the third elastic member.

The present invention further provides an operating structure including a housing, a first operating member, a first elastic member, a locking member, a second elastic member and a second operating member. The first operating member is disposed on the housing. The first elastic member connects to the housing and the first operating member. The locking member abuts against the first operating member or separates from the first operating member. The second elastic member connects to the housing and the locking member. The second operating member is rotatable about a first rotation axis, or is restricted from moving by the locking member.

The present invention still further provides an operating structure including a first operating member, a first elastic member, a locking member, a second elastic member and a second operating member. The first operating member is movable between a first position and a second position. The first operating member is at the first position or the second position with the first elastic member. The locking member abuts against the first operating member in response to being in a disengaging position, and is separated from the first operating member in response to being in an engaging position. The second elastic member applies a force to the locking member toward the engaging position. The second operating member is rotatable toward a retraction direction and/or an extension direction, or is at a retracted position by the locking member.

In order to better understand the above and other aspects of the present invention, embodiments are described below in detail with reference to the accompanying drawings.

### BRIEF DESCRIPTION OF THE DRAWINGS

FIG. 1A is a top view of an operating structure according to one embodiment of the present invention.

FIG. 1B is a bottom view of the operating structure of FIG. 1A.

FIG. 2A is a top view of the operating structure of FIG. 1A, illustrating the first operating member rotating from the first position of FIG. 1A to the second position, and the second operating member switching from the retracted state shown in FIG. 1A to the extended state.

FIG. 2B is a bottom view of the operating structure of FIG. 2A.

FIG. 3A is a top view of the operating structure of FIG. 1A, illustrating the first operating member located at the second position, and the second operating member in the expanded state further rotating toward the extension direction.

FIG. 3B is a bottom view of the operating structure of FIG. 3A.

FIG. 4A is a top view of the operating structure of FIG. 1A, illustrating the first operating member located at the first position, and the second operating member in the expanded state located at the initial expanded position.

FIG. 4B is a bottom view of the operating structure of FIG. 4A.

### DETAILED DESCRIPTION

Various embodiments of the present invention will be described in detail below with reference to the accompanying drawings as examples. In addition to these detailed descriptions, the present invention can be widely implemented in other embodiments. Any readily available substitutions, modifications, and equivalent changes to the described embodiments are included within the scope of the present invention, which shall be defined by the claims. In the detailed description of the specification, numerous specific details and practical examples are provided to offer the reader a more complete understanding of the present invention; however, these specific details and practical examples should not be regarded as limitations of the present invention. Furthermore, well-known steps or elements are not described in detail to avoid causing unnecessary limitations to the present invention.

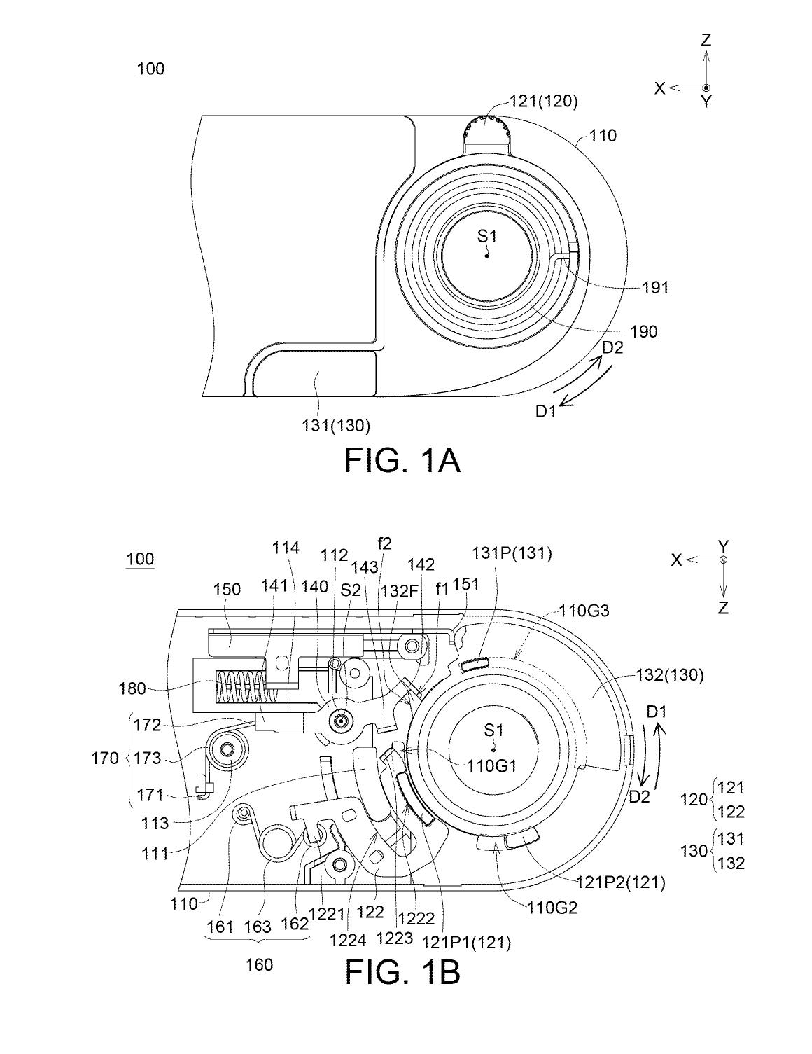

FIG. 1A is a top view of an operating structure 100 according to one embodiment of the present invention. FIG. 1B is a bottom view of the operating structure 100 of FIG. 1A.

Referring to FIGS. 1A and 1B, the operating structure 100 includes a housing 110, a first operating member 120 and a second operating member 130. The first operating member 120 and the second operating member 130 are rotatably disposed on the housing 110. In one embodiment, the first operating member 120 and the second operating member 130 may rotate about a rotation axis S1, wherein the rotation axis S1 is parallel to the Y-axis. In one specific embodiment, the user may rotate the first operating member 120 and/or the second operating member 130 so as to perform different functions.

In one embodiment, the first operating member 120 may include a first rotary dial 121 and a first linking member 122. The first rotary dial 121 and the first linking member 122 may be respectively disposed on different sides of the housing 110. Specifically, the housing 110 may be disposed on the XZ plane. As shown in FIG. 1A, the first rotary dial 121 may be disposed on a side of the housing 110 in a positive Y-axis direction for the user to operate. As shown in FIG. 1B, the first linking member 122 may be disposed on a side of the housing 110 in a negative Y-axis direction. The housing 110 may have a first sliding slot 110G1 penetrating through the Y-axis, and the first sliding slot 110G1 extends circumferentially with the rotation axis S1 as the center of a circle. The first rotary dial 121 may include a first slider 121P1, and the first slider 121P1 protrudes toward the negative Y-axis direction. The first linking member 122 may have a notch 1222 matching the first slider 121P1. The first slider 121P1 of the first rotary dial 121 may pass through the first sliding slot 110G1 to be coupled with the notch 1222 of the first linking member 122, such that the first linking member 122 interlocks with the first rotary dial 121. When the user toggles the first rotary dial 121 such that the first rotary dial 121 rotates about the rotation axis S1 due to an external force, the first linking member 122 can be synchronously driven to rotate about the rotation axis S1.

The first operating member 120 may move between a first position and a second position. Referring to FIG. 1B, the first sliding slot 110G1 of the housing 110 has two opposite closed terminals, and the first slider 121P1 of the first rotary dial 121 may move within the first sliding slot 110G1. When the first slider 121P1 is respectively positioned at the two opposite closed terminals of the first sliding slot 110G1, the first operating member 120 is respectively located at the first position and the second position.

In one embodiment, the housing 110 may further have a second sliding slot 110G2 penetrating through the Y-axis, and the second sliding slot 110G2 may extend circumferentially with the rotation axis S1 as the center of a circle. The first rotary dial 121 may further include a second slider 121P2, and the second slider 121P2 protrudes toward the negative Y-axis direction. The second slider 121P2 of the first rotary dial 121 may pass through the second sliding slot 110G2 and move therein. In another embodiment, the configuration of the second sliding slot 110G2 and the second slider 121P2 may be omitted.

Referring to FIG. 1B, the first linking member 122 may have a guide slot 1224. The guide slot 1224 has a circular arc curve, and the circular arc is centered on the rotation axis S1. The guide slot 1224 has a closed end facing a retraction direction D1 and an open end facing an extension direction D2. The housing 110 has a guiding protrusion 111, and the guiding protrusion 111 may enter the guide slot 1224 via the open end of the guide slot 1224. When the first operating member 120 rotates about the rotation axis S1, the first linking member 122 may rotate about the rotation axis S1 and may move in a circumferential direction centered on the rotation axis S1 by the guide slot 1224 and the guiding protrusion 111.

Referring to FIG. 1B, the operating structure 100 further includes a locking member 140, a translation member 150, a first elastic member 160, a second elastic member 170 and a third elastic member 180. The locking member 140, the translation member 150, the first elastic member 160, the second elastic member 170 and the third elastic member 180 are disposed on the housing 110 and may be disposed on the side of the housing 110 in the negative Y-axis direction.

Referring to FIGS. 1A and 1B, the first operating member 120 is located at the first position. The first elastic member 160 connects to the housing 110 and the first operating member 120. The first operating member 120 is maintained at the first position or the second position by the first elastic member 160. More specifically, the first elastic member 160 has an elastic force. If an external force is applied toward the retraction direction D1 to toggle the first rotary dial 121, the first elastic member 160 may provide the first operating member 120 with an elastic force toward the retraction direction D1, which may cause a tendency for the first operating member 120 to continuously move toward the first position. If an external force is applied toward the extension direction D2 to rotate the first rotary dial 121, the first elastic member 160 may provide the first operating member 120 with an elastic force toward the extension direction D2, which may cause a tendency for the first operating member 120 to continuously move toward the second position.

Referring to FIG. 1B, the first operating member 120 may connects to the first elastic member 160 by the first linking member 122. The first linking member 122 may include a hook portion 1221. In one specific embodiment, the first elastic member 160 is a torsion spring. A first end 161 of the first elastic member 160 connects to the housing 110, and a second end 162 connects to the hook portion 1221 of the first linking member 122. Since the first elastic member 160 may connects to the housing 110 only by the first end 161, that is, a loop portion 163 of the first elastic member 160 is not fixed to the housing 110, only the first end 161 remains stationary when the first linking member 122 moves in the circumferential direction. The loop portion 163 and the second end 162 move along with the first linking member 122, such that the first elastic member 160, at different positions, provides forces in different directions to the first linking member 122. In more detail, referring to FIGS. 1A and 1B, if it is desired to change the first operating member 120 from the first position to the second position, an external force may be applied toward the extension direction D2 to toggle the first rotary dial 121. At this time, the first elastic member 160 may provide an elastic force for moving the first linking member 122 toward the extension direction D2. Conversely, if it is desired to change the first operating member 120 from the second position to the first position, an external force may be applied toward the retraction direction D1 to toggle the first rotary dial 121. At this time, the first elastic member 160 may provide an elastic force for moving the first linking member 122 toward the retraction direction D1. Thereby, the first elastic member 160 may allow the user to perceive a force feedback sensation during operation.

Referring to FIGS. 1A and 1B, in one embodiment, the second operating member 130 may include a second rotary dial 131 and a second linking member 132. The second rotary dial 131 and the second linking member 132 may be respectively disposed on different sides of the housing 110. Specifically, as shown in FIG. 1A, the second rotary dial 131 may be disposed on the side of the housing 110 in the positive Y-axis direction; as shown in FIG. 1B, the second linking member 132 may be disposed on the side of the housing 110 in the negative Y-axis direction. The housing 110 may have a third sliding slot 110G3 penetrating through the Y-axis, and the third sliding slot 110G3 may extend circumferentially with the rotation axis S1 as the center of a circle. An extension length of the third sliding slot 110G3 is a maximum angle at which the second operating member 130 can rotate. The second rotary dial 131 may include a third slider 131P, and the third slider 131P protrudes toward the negative Y-axis direction. The second linking member 132 may have an opening matching the third slider 131P. The third slider 131P of the second rotary dial 131 may pass through the third sliding slot 110G3 to be coupled with the opening of the second linking member 132, such that the second linking member 132 interlocks with the second rotary dial 131. When the second rotary dial 131 rotates about the rotation axis S1 due to an external force, the second linking member 132 can be synchronously driven to rotate about the rotation axis S1; or, when the second linking member 132 is driven to rotate about the rotation axis S1, the second rotary dial 131 can be synchronously interlocked to rotate about the rotation axis S1.

The second operating member 130 may have a retracted state and an extended state. The second operating member 130 shown in FIG. 1A and FIG. 1B is in the retracted state. At this time, the second operating member 130 is maintained in a retracted position, and the second operating member 130 is stopped by the locking member 140 such that it cannot rotate toward the extension direction D2. Until the locking member 140 releases the engaging restriction, the second operating member 130 can then rotate toward the extension direction D2 away from the retracted position, so as to switch the second operating member 130 to the extended state.

The locking member 140 may move between an engaging position and a disengaging position. The locking member 140 shown in FIG. 1B is in the engaging position. Referring to FIG. 1B, the locking member 140 is rotatably disposed on the housing 110 about a rotation axis S2, wherein the rotation axis S2 is different from the rotation axis S1. In one embodiment, the locking member 140 may include a first arm 141 and a second arm 142. A center of the locking member 140 may be sleeved on a cylinder 112 of the housing 110, and the locking member 140 may rotate and swing between the engaging position and the disengaging position with the cylinder 112 as a supporting pivot.

Referring to FIG. 1B, the second elastic member 170 connects to the housing 110 and the locking member 140. The locking member 140 tends to be maintained in the engaging position by the second elastic member 170. In one specific embodiment, the second elastic member 170 is a torsion spring. A first end 171 of the second elastic member 170 connects to the housing 110, a second end 172 connects to the first arm 141 of the locking member 140, and a loop portion 173 is sleeved on a cylinder 113 of the housing 110. The second elastic member 170 continuously provides a tangential component force to the first arm 141 of the locking member 140, such that the locking member 140 tends to rotate toward the extension direction D2. Eventually, the first arm 141 of the locking member 140 abuts against a fixed wall 114 of the housing 110, thereby maintaining the locking member 140 in the engaging position.

The locking member 140 in the engaging position may abut against the second operating member 130 and stop the second operating member 130 from rotating toward the extension direction D2. Referring to FIG. 1B, in one embodiment, the second linking member 132 may include a fin portion 132F. The fin portion 132F may have a flat surface f1 and an inclined surface f2. The flat surface f1 is disposed on a side of the fin portion 132F toward the extension direction D2, and the inclined surface f2 is disposed on a side of the fin portion 132F toward the retraction direction D1. The locking member 140 may engage the flat surface f1 of the fin portion 132F by the second arm 142; therefore, the second operating member 130 is stopped and cannot rotate toward the extension direction D2, thereby maintaining the second operating member 130 in the retracted position.

Referring to FIG. 1B, the translation member 150 is linearly movably disposed on the housing 110. When the second operating member 130 is in the retracted position, the translation member 150 abuts against the second operating member 130 toward the negative X-axis direction. Herein, the translation member 150 may abut against the second linking member 132 of the second operating member 130 via an extension portion 151 extending toward the negative X-axis direction. The third elastic member 180 connects to the housing 110 and the translation member 150. The translation member 150 tends to push the second operating member 130 to rotate toward the extension direction D2 by the third elastic member 180. In one specific embodiment, the third elastic member 180 is a compression spring. One end of the third elastic member 180 connects to the housing 110, and the other end connects to the translation member 150. The third elastic member 180 shown in FIG. 1B is in a compressed state and continuously provides a force for moving the translation member 150 toward the negative X-axis direction, such that the translation member 150 abuts against the second linking member 132. However, since the locking member 140 stops the second operating member 130 to maintain the second operating member 130 in the retracted position, and an amount of torque provided by the locking member 140 to the second operating member 130 is greater than or equal to an amount of torque provided by the translation member 150 to the second operating member 130, a pushing action of the translation member 150 still cannot drive the second operating member 130 to rotate toward the extension direction D2 unless the locking member 140 releases the engaging restriction on the second operating member 130.

Referring to FIG. 1B, the first operating member 120 and the locking member 140 are separated from each other; therefore, the locking member 140 may be maintained in the engaging position by the second elastic member 170. If it is desired to release the engaging restriction of the locking member 140 on the second operating member 130, the first operating member 120 may be further moved from the first position toward the second position along the extension direction D2, such that the first operating member 120 and the locking member 140 abut against each other to push the locking member 140 to move toward the disengaging position.

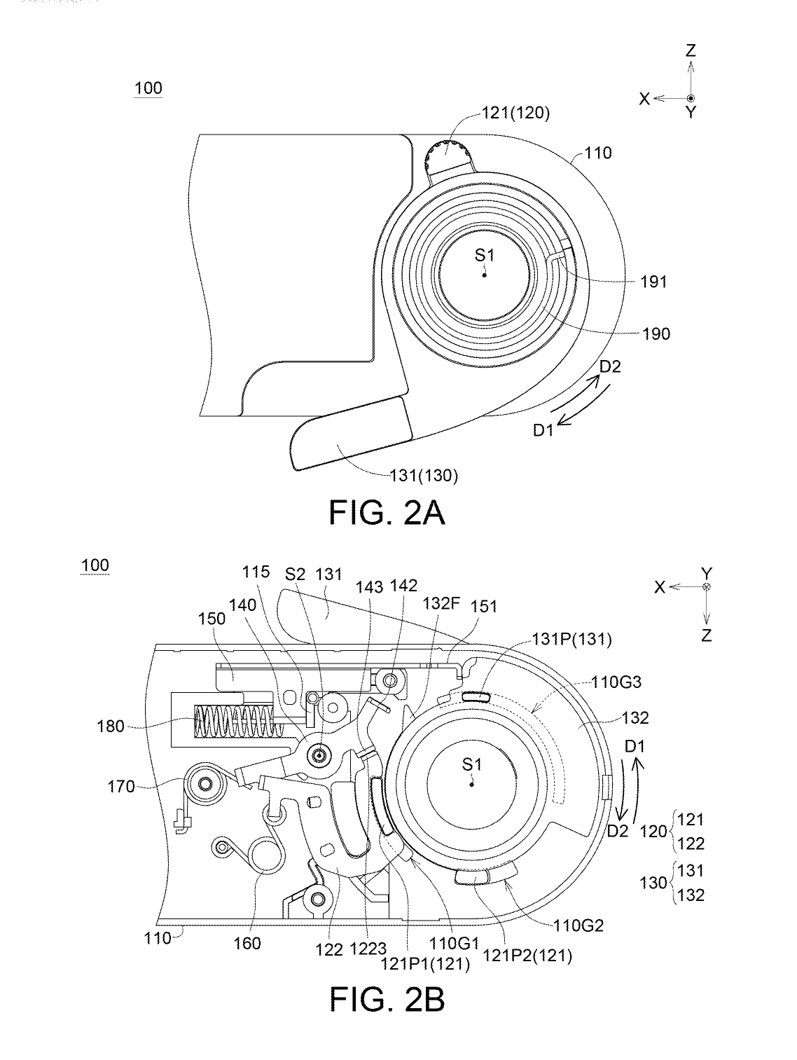

FIG. 2A is a top view of the operating structure 100 of FIG. 1A, illustrating the first operating member 120 rotating from the first position of FIG. 1A to the second position, and the second operating member 130 switching from the retracted state shown in FIG. 1A to the extended state. FIG. 2B is a bottom view of the operating structure 100 of FIG. 2A.

Referring to FIGS. 2A and 2B, the first linking member 122 may include a pushing portion 1223, and the locking member 140 may include a pushed portion 143. When an external force is applied toward the extension direction D2 to toggle the first rotary dial 121 of the first operating member 120, the first linking member 122 can be synchronously driven to rotate toward the extension direction D2. Then, the pushing portion 1223 of the first linking member 122 touches the pushed portion 143 of the locking member 140, and an amount of torque provided by the pushing portion 1223 to the locking member 140 is greater than an amount of torque provided by the second elastic member 170 to the locking member 140, thereby pushing the locking member 140 to rotate toward the retraction direction D1 and move toward the disengaging position. In this way, the second linking member 132 is no longer subject to the engaging restriction of the locking member 140 and thus can rotate toward the extension direction D2 by the pushing of the translation member 150. Simultaneously, the second linking member 132 also synchronously drives the second rotary dial 131 to rotate toward the extension direction D2 and expand outward. As shown in FIGS. 2A and 2B, the second operating member 130 at this time is in the extended state.

Referring to FIGS. 2A and 2B, the operating structure 100 may further include a fourth elastic member 190. The fourth elastic member 190 may be disposed on the side of the housing 110 in the positive Y-axis direction. The fourth elastic member 190 connects to the housing 110 and the second operating member 130. The second operating member 130 may tend to rotate toward the retraction direction D1 by the fourth elastic member 190. In one specific embodiment, the fourth elastic member 190 is a torsion spring. One end of the fourth elastic member 190 connects to the housing 110, and the other end 191 connects to the second rotary dial 131 of the second operating member 130. When the locking member 140 releases the engaging restriction on the second operating member 130, the translation member 150 moves toward the negative X-axis direction and pushes the second operating member 130 to rotate toward the extension direction D2 until the translation member 150 is blocked by a stopper wall 115 of the housing 110. At this time, the fourth elastic member 190 may store an elastic force for driving the second operating member 130 to rotate toward the retraction direction D1, such that the second operating member 130 is balanced at an initial extended position in the extended state.

Under this circumstance, an external force may be applied to toggle the second rotary dial 131 of the second operating member 130, such that the second rotary dial 131 further rotates toward the extension direction D2.

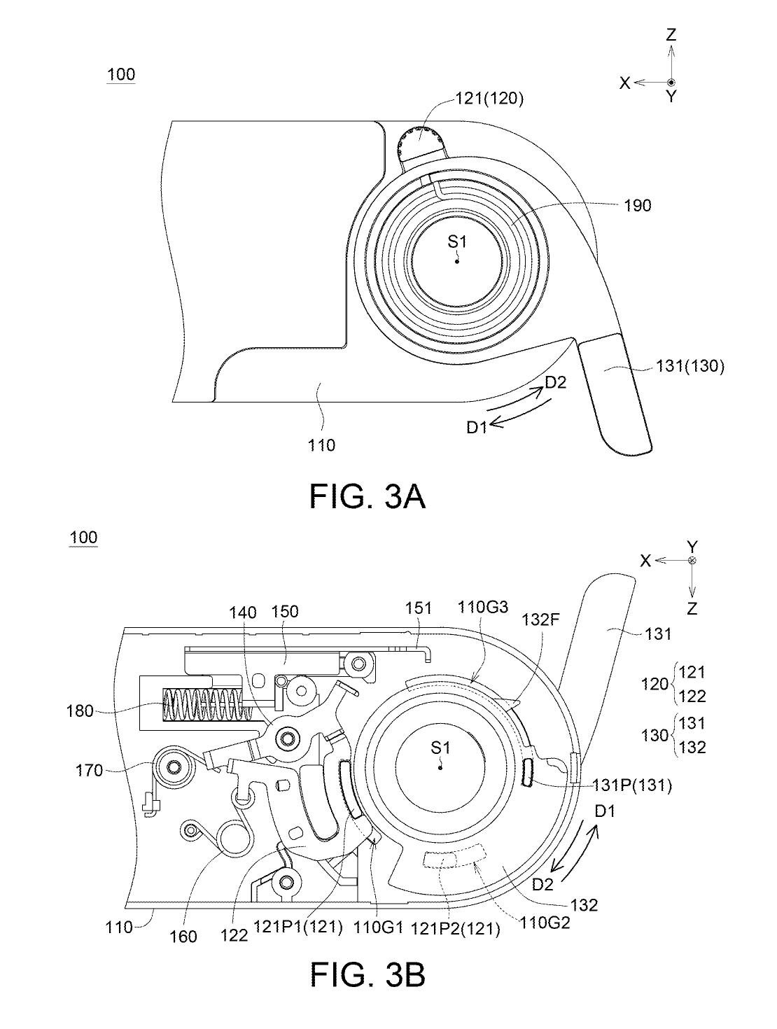

FIG. 3A is a top view of the operating structure 100 of FIG. 1A, illustrating the first operating member 120 located at the second position, and the second operating member 130 in the expanded state further rotating toward the extension direction D2. FIG. 3B is a bottom view of the operating structure 100 of FIG. 3A.

Referring to FIGS. 3A and 3B, the second operating member 130 may leave the initial extended position shown in FIGS. 2A and 2B to further rotate toward the extension direction D2, thereby departing from the translation member 150 due to an external force. During a process in which the second rotary dial 131 is subjected to the external force and the second linking member 132 is synchronously driven to rotate toward the extension direction D2, the fourth elastic member 190 continuously stores an elastic force. Once the external force on the second rotary dial 131 is released, the elastic force stored by the fourth elastic member 190 can drive the second operating member 130 to rotate toward the retraction direction D1 and return to the initial extended position shown in FIGS. 2A and 2B. Thereby, the fourth elastic member 190 may allow the user to perceive a force feedback sensation during operation.

That is, in the extended state, the second operating member 130 may tend to rotate toward the retraction direction D1 back to the initial extended position (as shown in FIGS. 2A and 2B) by the fourth elastic member 190. If an external force is further applied to the second operating member 130 such that the second operating member 130 rotates toward the retraction direction D1 to the retracted position, since the locking member 140 is still in the disengaging position, the second operating member 130 will be immediately pushed back to the initial extended position along the extension direction D2 by the translation member 150 once the external force is released.

Therefore, if it is desired to switch the second operating member 130 to the retracted state, the locking member 140 is first required to be moved to and maintained in the engaging position.

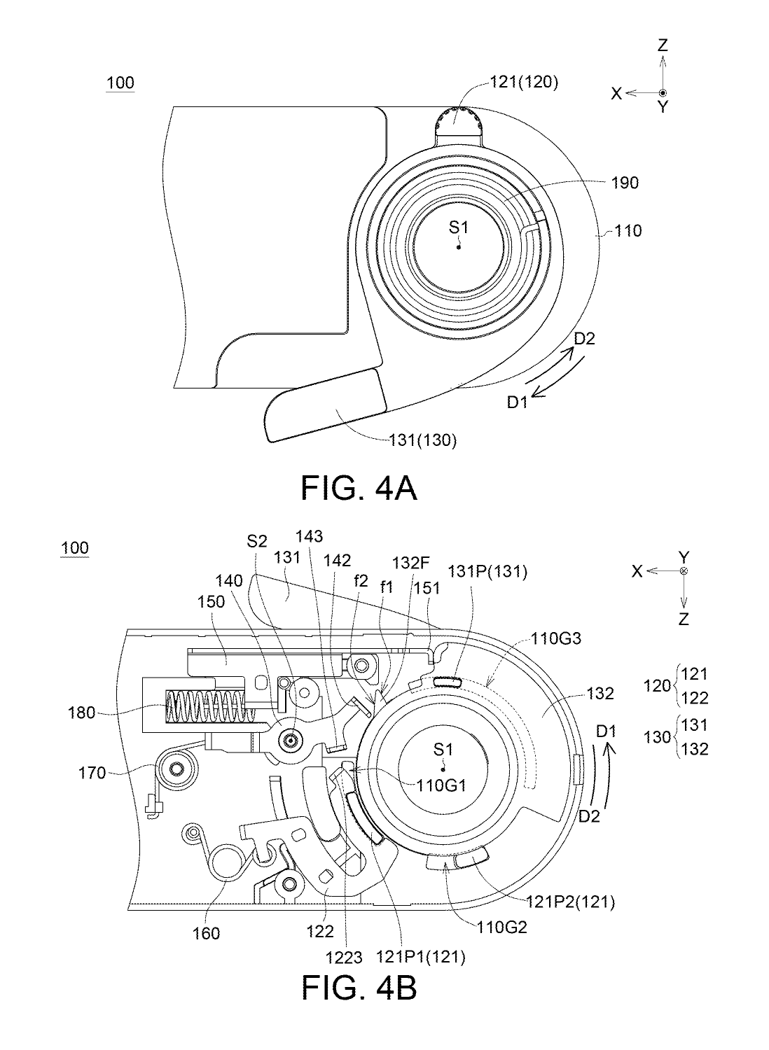

FIG. 4A is a top view of the operating structure 100 of FIG. 1A, illustrating the first operating member 120 located at the first position, and the second operating member 130 in the expanded state located at the initial expanded position. FIG. 4B is a bottom view of the operating structure 100 of FIG. 4A.

Referring to FIGS. 3A-4B at the same time, by applying an external force to the first operating member 120, the first operating member 120 may rotate from the second position shown in FIGS. 3A and 3B toward the retraction direction D1 to the first position shown in FIGS. 4A and 4B. The first operating member 120 may be maintained in the first position by the first elastic member 160, and the locking member 140 may return to the engaging position by the second elastic member 170. Under this circumstance, an external force may be applied toward the retraction direction D1 to toggle the second rotary dial 131 of the second operating member 130, and the second linking member 132 is also synchronously driven to rotate toward the retraction direction D1. During this process, the second linking member 132 pushes the second arm 142 of the locking member 140 via the inclined surface f2 of the fin portion 132F, such that the locking member 140 rotates slightly toward the retraction direction D1; until the inclined surface f2 no longer abuts against the locking member 140, the locking member 140 immediately rotates toward the extension direction D2, such that the second arm 142 engages the flat surface f1 of the fin portion 132F, thereby maintaining the second operating member 130 in the retracted position.

In one embodiment, the first operating member 120 and the second operating member 130 may respectively perform different functions of an electronic device. For example, the first operating member 120 may be a power switch of the electronic device, and the second operating member 130 may serve as a function adjustment key of the electronic device, such as a zoom-in/zoom-out function of a digital camera and a forward/rewind adjustment of an image file. Referring to FIGS. 2B and 3B, the second operating member 130 may rotate to different angles. The electronic device may detect a rotation angle of the second operating member 130 via a signal sensing module, thereby triggering a corresponding function adjustment signal.

Although the present invention has been disclosed above with reference to specific embodiments, it is not intended to limit the present invention. Those skilled in the art to which the present invention pertains may make various modifications and refinements without departing from the spirit and scope of the present invention. Therefore, the scope of the present invention shall be defined by the appended claims.

What is claimed is:

1. An operating structure comprising:
a housing;
a first operating member movable between a first position and a second position;
a first elastic member connecting to the housing and the first operating member, the first operating member being at the first position or the second position by the first elastic member;
a locking member movable between an engaging position and a disengaging position, wherein the first operating member and the locking member are separated from each other in the engaging position, and the first operating member and the locking member abut against each other in the disengaging position;
a second elastic member connecting to the housing and the locking member, the second elastic member applying a force to the locking member toward the engaging position;
a second operating member rotatable toward a retraction direction and an extension direction about a first rotation axis, in a retracted state, the locking member being at the engaging position, and the locking member stopping the second operating member at a retracted position; in an extended state, the second operating member departing from the retracted position and being rotatable toward the retraction direction and the extension direction;
a translation member abutting against the second operating member when the second operating member is in the retracted position; and
a third elastic member connecting to the housing and the translation member, the translation member applying a force to the second operating member toward the extension direction by the third elastic member.

2. The operating structure according to claim 1, wherein the first operating member comprises a first rotary dial and a first linking member, and the first operating member connects to the first elastic member with the first linking member.

3. The operating structure according to claim 2, wherein the first linking member moves along a circumferential direction of the first rotation axis, and the first rotary dial interlocks with the first linking member.

4. The operating structure according to claim 1, wherein the second operating member comprises a second rotary dial and a second linking member, and the second operating member connects to the translation member with the second linking member.

5. The operating structure according to claim 4, wherein the second rotary dial interlocks with the second linking member.

6. The operating structure according to claim 4, wherein the second linking member comprises a fin portion, the fin portion has an inclined surface and a flat surface, the inclined surface is on a side of the fin portion toward the retraction direction, and the flat surface is on a side of the fin portion toward the extension direction.

7. The operating structure according to claim 1, further comprising a fourth elastic member connects to the housing and the second operating member; wherein in the extended state, the fourth elastic member applies a force to the second operating member toward the retraction direction.

8. The operating structure according to claim 7, wherein in the extended state, the translation member and the fourth elastic member balance the second operating member at an initial extended position.

9. The operating structure according to claim 8, wherein in the extended state, the second operating member is movable away from the translation member by rotating from the initial extended position toward the extension direction.

10. The operating structure according to claim 1, wherein the locking member is rotatable about a second rotation axis on the housing.

11. An operating structure comprising:
a housing;
a first operating member being on the housing;
a first elastic member connecting to the housing and the first operating member;
a locking member abutting against or separating from the first operating member;
a second elastic member connecting to the housing and the locking member; and
a second operating member rotatable about a first rotation axis, or restricted from moving by the locking member.

12. The operating structure according to claim 11, wherein the first operating member comprises a first rotary dial and a first linking member, the first operating member connects to the first elastic member with the first linking member, and the first rotary dial interlocks with the first linking member.

13. The operating structure according to claim 12, further comprising a translation member, wherein the second operating member comprises a second rotary dial and a second linking member, the second operating member connects to the translation member with the second linking member, and the second rotary dial interlocks with the second linking member.

14. The operating structure according to claim 13, wherein the second linking member comprises a fin portion, and the fin portion has an inclined surface and a flat surface.

15. The operating structure according to claim 11, further comprising a translation member, wherein when the second operating member is in a retracted position, the translation member abuts against the second operating member.

16. The operating structure according to claim 15, further comprising a third elastic member, and the third elastic member connects to the housing and the translation member.

17. The operating structure according to claim 11, further comprising a fourth elastic member, and the fourth elastic member connects to the housing and the second operating member.

18. An operating structure comprising:
a first operating member movable between a first position and a second position;
a first elastic member, the first operating member being at the first position or the second position with the first elastic member;
a locking member abutting against the first operating member in a disengaging position, and the locking member and the first operating member are separated from each other in an engaging position;
a second elastic member applying a force to the locking member toward the engaging position; and
a second operating member being rotatable toward a retraction direction and/or an extension direction, or the second operating member being at a retracted position by the locking member.

19. The operating structure according to claim 18, further comprising a translation member and a third elastic member, wherein the translation member applies a force to the second operating member toward the extension direction by the third elastic member.

20. The operating structure according to claim 18, further comprising a fourth elastic member, wherein the fourth elastic member applies a force to the second operating member toward the retraction direction.
